(19) United States
(12) Patent Application Publication
(10) Pub. No.: US 2012/0158238 A1
(43) Pub. Date: Jun. 21, 2012

(54) LOCATION BASED AUTOMOBILE INSPECTION

(76) Inventors: Marcus Isaac Daley, Highland, UT (US); Elias Leonel More Basso, Montevideo (UY)

(21) Appl. No.: 13/347,575

(22) Filed: Jan. 10, 2012

Related U.S. Application Data
(63) Continuation-in-part of application No. 12/836,527, filed on Jul. 14, 2010.

(51) Int. Cl. G06F 7/00; H04N 7/18; G10L 21/00

(52) U.S. Cl. 701/29.1; 704/275; 704/E21.001; 348/E07.085

(57) ABSTRACT

A dynamic inspection system determines a location of a technician with respect to an inspection vehicle and determines active voice commands to which it responds to based on that location. The technician can perform a vehicle inspection by providing voice commands to the dynamic inspection system, which can increase the technician's efficiency. Further, as the dynamic inspection system's active commands are customized for the location of the technician, the dynamic inspection system can filter out sound that does not include active voice commands, potentially increasing the accuracy of its voice recognition capability.

### CROSS-REFERENCE TO RELATED APPLICATIONS

This application is a continuation-in-part of U.S. application Ser. No. 12/836,527, filed Jul. 14, 2010, the entire contents of which are hereby incorporated by reference herein and made part of this specification.

### BACKGROUND OF THE DISCLOSURE

1. Field

This disclosure generally relates to systems methods for customizing an automobile inspection based partly on the current area of the automobile being inspected, among other features.

2. Description of the Related Art

Automobiles have many components and systems that function alone, or in coordination, to allow proper operation of the vehicle. Examples of such systems and components may include, but are not limited to, brake systems, emissions systems, transmission systems, belts, hoses, fluid levels, tires, etc. In order to ensure that proper operation of the vehicle is maintained, vehicle inspections and repairs are typically recommended by the vehicle manufacturer at selected intervals in order to check the operation of the vehicle's many components and systems.

In order to assist in the inspection and repair process, vehicle inspection forms, lists, or checklists are often utilized. An inspection checklist provides an inventory of components to check during a vehicle inspection. In one example, such a list may be generated by a vehicle manufacturer. In another example, inspection checklists may be generated by individual automobile repair facilities. In this manner, a technician or mechanic can be advised of a variety of systems and/or components to inspect and/or repair.

Unfortunately, these inspection checklists function as “one-size-fits-all” and are used regardless of what area of the vehicle is being inspected. Accordingly, these checklists cover inspections for all areas of the vehicle and can therefore be long and complicated. Thus, these static inspection checklists can potentially waste the vehicle owner's time and money, since they may result in longer inspection times as repair technicians hunt for pertinent sections or they may result in missed inspection items if the technician misses a pertinent section.

### SUMMARY

In one embodiment, a dynamic inspection system generates a dynamic inspection checklist comprising one or more tasks that are recommended for a particular inspection area of a vehicle a repair technician is inspecting. As the checklist is customized for the particular inspection area, more time and energy can be spent by the technician determining and implementing a proper course of action based on specific tasks for that inspection area, allowing a targeted inspection rather than a more general inspection of the entire vehicle. This targeted approach, in turn, raises the likelihood of a successful inspection and/or repair outcome by the repair technician, saving the vehicle owner time and money.

In one embodiment, a computerized method of generating a customized vehicle inspection checklist comprises obtaining one or more images of at least a portion of a vehicle and a technician proximate the vehicle, determining, based at least on the one or more images, a real-time location of the technician relative to the vehicle; determining a section of the vehicle proximate to the technician based at least on the real-time location, determining one or more vehicle inspection tasks associated with the determined section of the vehicle, generating a first customized vehicle inspection checklist including the one or more inspection tasks, and transmitting at least a portion of the first customized inspection checklist to a technician device proximate the technician so as to communicate to the technician the one or more inspection tasks associated with the vehicle section proximate the technician.

In one embodiment, a method of determining inspection tasks for a particular section of a vehicle comprises determining by a computing device a section of a vehicle nearest a user, accessing a data structure comprising associations between vehicle sections and respective one or more inspection tasks, and selecting a first one or more inspection tasks associated with the determined section of the vehicle in the data structure.

In one embodiment, a system for generating an inspection form for use by a user during a vehicle inspection comprises one or more processor configured to execute software modules including at least: a location module configured to determine a location of a user within a vehicle inspection area, and a dynamic inspection module configured to: determine a vehicle section proximate to the user based on the determined location of the user, determine vehicle data associated with the determined vehicle section; and communicate the vehicle data to a computing device configured to display at least a portion of the vehicle data.

In one embodiment, a portable computing device comprises a processing unit, a display for displaying an inspection form, and an inspection module configured to: obtain location data usable to determine a location of the portable computing device with respect to a vehicle, receive a vehicle section proximate to the portable computing device, wherein the vehicle section is determined based at least on the determined location of the portable computing device with respect to the vehicle, receive one or more tasks associated with the determined vehicle section proximate to the portable computing device, and display at least some of the received one or more tasks associated with the determined vehicle section.

### BRIEF DESCRIPTION OF THE DRAWINGS

FIG. 1A is a block diagram of a dynamic inspection system configured to generate customized inspection checklists based on the current inspection area of a vehicle;

FIG. 1B is a block diagram of another embodiment of the dynamic inspection system;

FIGS. 2A-2B illustrate embodiments of the dynamic inspection system including one or more location reporters;

FIG. 3 illustrates an embodiment of the dynamic inspection system using signal strength to determine location;

FIG. 4 illustrates an embodiment of the dynamic inspection system using RFID tags to determine location;

FIG. 5 illustrates a block diagram of an embodiment of a technician device;

FIGS. 6A-6B illustrate front and back views, respectively, of an embodiment of the technician device;

FIG. 7A illustrates a flow chart of an embodiment of a location determination process using images;

FIG. 7B illustrates a flow chart of another embodiment of a location determination process using an image acquired from a technician device;

FIG. 8 illustrates a flow chart of another embodiment of a location determination process using an electronic signal;

FIG. 9 illustrates a flow chart of an embodiment of a technician device location process described in FIG. 8;

FIG. 10 illustrates a flow chart of an embodiment of a task list generation process for generating customized inspection lists;

FIG. 11A illustrates a sample data flow between the technician device and an embodiment of a dynamic inspection module;

FIG. 11B illustrates a sample data flow between an embodiment of the dynamic inspection module and at least one camera;

FIGS. 12A-12B illustrate embodiments of a dynamic inspection checklist generated for specific inspection areas of a vehicle;

FIG. 13 illustrates an embodiment of the dynamic inspection system configured to accept and respond to voice commands; and

FIG. 14 illustrates a flow chart of another embodiment of a location determination process using a camera.

### DETAILED DESCRIPTION

Embodiments of the disclosure will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the disclosure. Furthermore, embodiments of the disclosure may include several novel features, no single one of which is solely responsible for its desirable attributes or which is essential to practicing the systems and methods herein described.

The terms “vehicle” and “automobile,” as used herein, may comprise any vehicle, automobile, airplane, tractor, boat, or other motorized device, as well as other types of devices that may require inspections and/or repairs, such as electronic devices, including computers and computerized devices, for example. Thus, any reference herein to an automobile or vehicle should be construed to cover any other apparatus or device.

### Overview

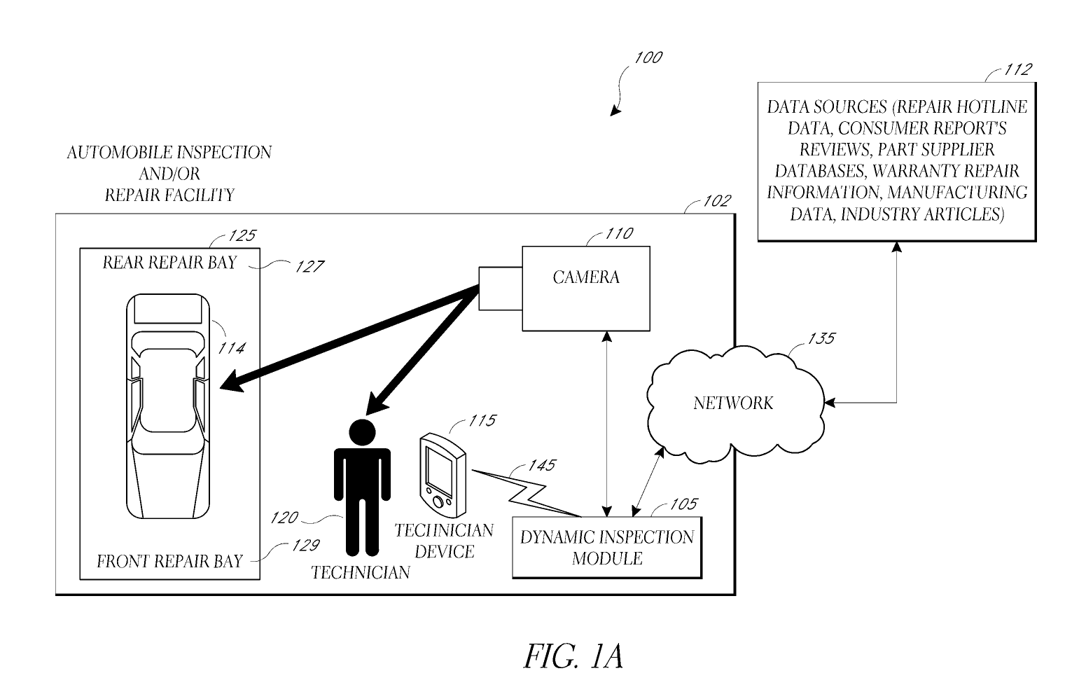

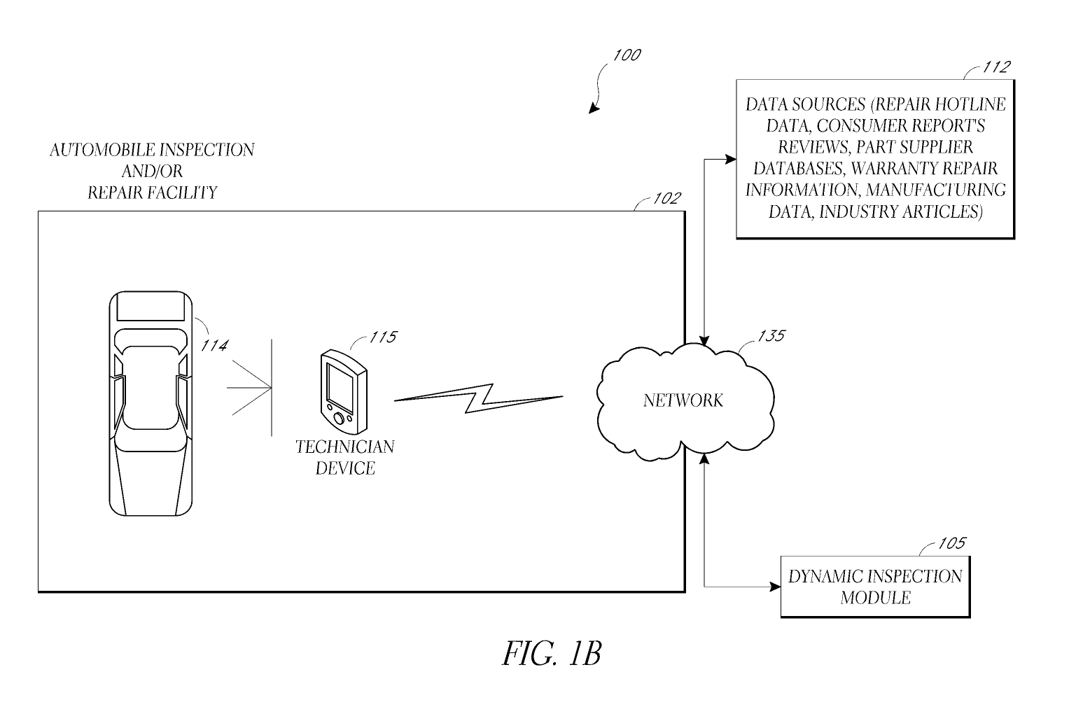

FIG. 1A is a block diagram of a dynamic inspection system 100 that is configured to generate customized inspection checklists based on the current inspection area on a vehicle. In one embodiment, an automobile inspection and/or repair facility 102 (referred to herein as simply the “repair facility 102”) includes a dynamic inspection module 105. The dynamic inspection module 105 accesses and/or receives data from one or more cameras 110 and/or one or more data sources 112 in order to determine a location of a technician 120 with respect to a vehicle under inspection and to customize an inspection report provided to the technician 120 based on the determined location.

Advantageously, the dynamic inspection module 105 can analyze the data from the one or more cameras 110 and identify the current area of the vehicle 114 being inspected by a technician 120 (referred to herein as an “inspection area”). In one embodiment, the inspection area is determined based on the location of the technician 120 relative to the vehicle 114, as determined by images acquired by the camera 110. The dynamic inspection module 105 can then generate a customized inspection checklist for the current inspection area from data from the one or more data sources 112. One or more data sources 112 may be local to the dynamic inspection module 105 (e.g., coupled to a same local area network) and/or may be accessed via multiple network connections, such as via an Internet connection. The data sources 112 may include data from one or more of repair hotlines, consumer report data providers, automobile parts suppliers, warranty repair providers, manufacturing data, industry articles, and many other providers of data that are relevant to inspections and/or repairs of vehicles.

The customized inspection checklist can be transmitted to a technician device 115 so that the technician 120 receives information that is relevant to a section of the vehicle that he is currently examining and/or is near to. In one embodiment, the technician device 115 is a portable computing device carried by the technician 120, for example, during inspections.

In one embodiment, the repair facility 102 comprises a data store that stores data associated with vehicle 114 and/or technician 120 location, inspection, repairs, and/or repair results, for example, that are performed/observed at the repair facility 102. In one embodiment, the repair facility 102 comprises an automobile repair shop, such as that of a dealership, fleet maintenance depot, or independent mechanic. In another embodiment, the repair facility 102 may comprise an airplane hanger for an airline that performs repairs on a vehicle. In another embodiment, the repair facility 102 may comprise the home or workshop of a consumer who performs maintenance operations on a vehicle, though the consumer may view vehicle maintenance information without necessary performing maintenance operations.

The one or more cameras 110 can be positioned throughout the repair facility 102. The one or more cameras can be still or video, digital or analog and are in communication with the dynamic inspection module 105 using a communications medium 140. The communications medium can be wired or wireless and can include transmission through a communications network 135, for example, if the dynamic inspection module 105 is located outside the repair facility 102. The one or more cameras can be placed such that the vehicle 114 and/or repair bay 125 is within view of the cameras 110. In one embodiment, multiple cameras positioned with different perspectives of the vehicle are used to aid in determining the relative location of the technician 120 to the vehicle 114. For example, if the technician 120 appears in an image taken by a camera viewing the back of the vehicle, the technician 120 can be determined to be inspecting the rear of the vehicle. In some embodiments, a single camera can be used to acquire images of the technician 120 and vehicle 114, and the image may be processed to determine the location of a technician 120 relative to the vehicle 114. For example, a camera, such as a wide angle camera, may be placed on a ceiling above an area where vehicles are positioned for inspections so that the camera captures images of vehicles in that space, as well as technicians around the vehicles. Images from the one or more cameras can be sent to the dynamic inspection module 105 and/or other image processing module, which can process the images and determine a current location of the technician 120.

In operation, the dynamic inspection module 105 receives data from the one or more cameras 110 directly or through the network 135. The network 135 may include any combination of one or more networks, such as LANs, WANs, and/or the Internet, that provide a communication medium that may be accessed via wired and/or wireless communication protocols. From the received data, the dynamic inspection module 105 can determine a location of the technician 120 relative to the inspection vehicle 114. Various image processing techniques, such as pose estimation, where the position of a specific object relative to the camera is determined, may be used. For example, the dynamic inspection module 105 may contain a reference image for the repair facility and can compare a current image of the technician 120 with the reference image to determine the technician's 120 location in the repair facility 102. In one embodiment, the dynamic inspection module 105 can determine the technician's 120 location relative to the vehicle 114 based on whether and/or what portions of the vehicle 114, repair facility and/or technicians 120 are occluded as the technician 120 moves around the vehicle. For example, if the technician 120 moves between the side of the vehicle 114 and the camera 110, the technician 120 can then be determined to be beside the vehicle 114. If the placement and orientation of the vehicle 114 within the repair facility 102 is known, then the technician 120 can further be determined to be facing a particular area, for example, the left side of the vehicle. In some embodiments, the size of the technician 120 in the image frame can be used to determine the location of the technician 120 relative to the camera. Various other image processing techniques, such as background subtraction, can be used to determine the location of the technicians 120. Additionally, in some embodiments, the image processing software may detect locations of multiple technicians near the inspection vehicle 114 such that inspection information may be customized for the different technicians based on their respective locations.

In some embodiments, the position and/or placement of the vehicle 114 are already known, providing a known reference point for the technician 120. In one embodiment, placement of the vehicle is determined based on its placement relative to a known location, such as a repair bay 125. For example, the inspection vehicle may be positioned in the repair bay with the rear of the vehicle at the rear of the repair bay 127 and the front of the vehicle in the front of the repair bay 129. As the positioning of the repair bay is static and known, the locations of the vehicle portions can be determined by their position relative to the repair bay 129. Thus, for example, the portion of the vehicle near the front of the bay 125 can be determined to be the front of the vehicle 114. Knowledge of the vehicle placement can then be used to simplify determination of the technician's 120 position with reference to the vehicle 114.

After obtaining location and inspection information, such as potential inspection items for the vehicle 114, the dynamic inspection module 105 provides one or more recommended tasks, for example, inspection, repair, and/or other user tasks, for inclusion on a dynamic inspection checklist based on the determined particular inspection area. For example, if the technician 120 is determined to be located near the engine compartment (or simply the front) of the vehicle 114, then the checklist can include checklist items related to the engine bay, such as checking oil, fluids, belts, or the like. After generating the customized checklist, the dynamic inspection module 105 can transmit the customized inspection checklist to the technician device 115 for use by the technician 120. Furthermore, the dynamic inspection checklist can be updated in real-time as the technician 120 (and the technician device 115) moves around the vehicle 114 in order to provide information to the technician 120 that is relevant to the vehicle portion nearest the technician 120.

In one embodiment, the dynamic inspection module 105 identifies inspection tasks that are customized for respective inspection areas of the vehicle 114 based on data received from the one or more data sources 112 regarding vehicles similar to the inspection vehicle 114. In one embodiment, the data received from one or more data sources 112 comprises one or more of symptom reports, recommended inspections and/or repairs, repairs (that were actually performed on respective vehicles), effectiveness of repairs performed, consumer repair inquiry data, warranty information, replacement part sales/use data, and/or any other data that may be useful in determining inspection items for the vehicle. The data received from the data sources 112 may then be used by the dynamic inspection module 105 to provide inspection tasks that are relevant to a particular inspection area.

In one embodiment, the dynamic inspection module 105 generates a dynamic inspection checklist (also referred to herein as a “dynamic inspection report”, or simply a “dynamic inspection”) comprising one or more tasks that are recommended for the particular inspection area of the vehicle the technician 120 is determined to be currently inspecting. This dynamic inspection checklist can be different then conventional inspections checklists that include inspection tasks that are generic to an entire vehicle. The dynamic inspection checklist may also include reference information associated with a particular inspection, such as information on topics including, but not limited to, warrantees, recalls, customer surveys, independent reviews, and the experiences of large numbers of mechanics and technicians in an organized and timely manner. Thus, more time and energy can be spent at the repair facility 102 efficiently determining and implementing a course of action based on the recommendations and additional considerations provided by the dynamic inspection module 105, allowing a targeted inspection rather than a more general inspection of the entire vehicle. This targeted approach, in turn, raises the likelihood of a successful inspection and/or repair outcome at the repair facility 102, saving the customer time and money. In one embodiment, the dynamic inspection module 105 determines the most relevant inspection items for areas of the vehicle currently under inspection by the technician 120 using one or more techniques described in co-pending patent application Ser. No. 12/020,347, filed on Jan. 25, 2008, and entitled “Smart Inspections,” which is hereby incorporated by reference in its entirety for all purposes.

The technician device 115 can display the checklist corresponding to a particular inspection area, thereby allowing the technician 120 to make a focused inspection. The technician device 115 can include a display for displaying the checklist and an I/O interface for receiving and/or transmitting data. In one embodiment, the technician device is in wireless communication 145 with the dynamic inspection module 105, providing freedom of movement to the technician 120 operating the technician device. In other embodiments, the dynamic inspection module 105 or portions thereof, are included in the technician device 115.

In the embodiment of FIG. 1A, the dynamic inspection module 105 is in data communication with a network 135, which comprises one or more networks, such as LANs, WANs, and/or the Internet, for example, via a wired and/or wireless communication link. The network 135 is also coupled to one or more data sources 112, such as original equipment manufacturers (OEMs) of vehicles, repair hotline data sources, Consumer Reports review data sources, parts supplier databases, and warranty repair information data sources, discussed in greater detail below. The network 135 is further coupled to one or more automobile inspection and/or repair facilities 102. Depending on the embodiment, the repair facility 102 may serve as both a data source 112, e.g., by providing repair recommendation information for vehicles inspected at the particular repair facility 102, and a user of the customized inspection checklists provided by the dynamic inspection module 105. In FIG. 1A, the dynamic inspection module 105 can be found within the repair facility, but, in other embodiments, the dynamic inspection module 105 may be located elsewhere and in communication with the one or more cameras 110 and the technician device 110 through the network 135.

In addition to transferring relevant recommendation and repair data via the network 135, certain data sources 112 may transmit data to the dynamic inspection module 105 via other means, such as on a tangible, moveable media, such as DVD, CD-ROM, flash memory, thumb drive, etc., that may be delivered to an administrator of the dynamic inspection module 105. In other embodiments, the dynamic inspection module 105 is in communication with fewer or more devices than are illustrated in FIG. 1A. In one embodiment, certain functionalities described herein with respect to the dynamic inspection module 105 are performed, partly or completely, by other device, such as computing devices of one or more data sources 112 and/or computing devices of the repair facility 102, such as the technician device 115.

In the embodiment of FIG. 1A, the exemplary dynamic inspection module 105 includes any combination of software, firmware, and hardware. For example, the dynamic inspection module 105 may include only software code that may be executed by suitable computing devices (e.g., a computer or server). Alternatively, the dynamic inspection module 105 may include a computing device, such as a computing device having one or more central processing units (“CPU”), which may each include conventional microprocessors or any other processing unit. In this embodiment, the dynamic inspection module 105 further includes one or more memory devices, such as random access memory (“RAM”) for temporary storage of information and a read only memory (“ROM”) for permanent storage of information, and one or more mass storage devices, such as hard drives, diskettes, or optical media storage devices. In one embodiment, the dynamic inspection module 105 includes a data store for storing inspection-related data. In one embodiment, the modules of the dynamic inspection module 105 are in communication via a standards based bus system, such as bus systems using Peripheral Component Interconnect (PCI), Microchannel, SCSI, Industrial Standard Architecture (ISA) and Extended ISA (EISA) architectures and others. In certain embodiments, components of the dynamic inspection module 105 communicate via one or more networks 135, such as a local area network that may be secured.

In general, the dynamic inspection module, as used herein, refers to logic embodied in hardware or firmware, or to a collection of software instructions, possibly having entry and exit points, written in a programming language, such as C, C# or C++. A software module may be compiled and linked into an executable program, installed in a dynamic link library, or may be written in an interpreted programming language such as BASIC, Perl, or Python. It will be appreciated that software modules may be callable from other modules or from themselves, and/or may be invoked in response to detected events or interrupts. Software instructions may be embedded in firmware, such as an EPROM. The modules described herein are preferably implemented as software modules, but may be represented in hardware or firmware. Moreover, although in some embodiments a module may be separately compiled, in other embodiments a module may represent a subset of instructions of a separately compiled program, and may not have an interface available to other logical program units.

In one embodiment, the dynamic inspection module 105 comprises a server based system. In other embodiments, the dynamic inspection module 105 may comprise any other computing device, such as a computing device or server that is IBM, Macintosh, or Linux/Unix compatible. In another embodiment, the dynamic inspection module 105 comprises a desktop personal computer (PC), a laptop computer, a cellular phone, personal digital assistant (PDA), a kiosk, or an audio player, for example.

The dynamic inspection module 105 and/or technician device 115 are generally controlled and coordinated by operating system software, such as server based software. In other embodiments, the dynamic inspection module 105 and/or technician device 115 comprise modules that execute one or more other operating systems, such as Windows 95, Windows 98, Windows NT, Windows 2000, Windows XP, Windows Vista, Windows 7, Windows Server, Linux, SunOS, Solaris, PalmOS, Blackberry OS, or other desktop or server operating systems. In Macintosh systems, the operating system may be any available operating system, such as MAC OS X. In other embodiments, the dynamic inspection module 105 may be controlled by a proprietary operating system. Conventional operating systems control and schedule computer processes for execution, perform memory management, provide file system, networking, and I/O services, and provide a user interface, such as a graphical user interface (“GUI”), among other things.

The dynamic inspection module 105 can include one or more commonly available input/output (I/O) devices and interfaces (not shown), such as a keyboard, mouse, touchpad, speaker, and printer. In one embodiment, the I/O devices and interfaces include one or more display device, such as a monitor, that allows the visual presentation of data to a user. More particularly, a display device provides for the presentation of GUIs, application software data, and multimedia presentations, for example. The dynamic inspection module 105 may also include one or more multimedia devices, such as speakers, video cards, graphics accelerators, and microphones, for example.

FIG. 1B is a block diagram of another embodiment of the dynamic inspection system 100. In this embodiment, the technician device 115 is in communication with the dynamic inspection module 105 via the network 135. The dynamic inspection module 105 also accesses and/or receives data from one or more data sources 112 via the network 135.

In this embodiment, the technician device 115 can include a location module for determining the location of the technician device 115 in relation to the inspection vehicle 114. Presumably, the technician device 115 is being operated by a technician 120 and, thus, the location of the technician device 115 can be used to determine the inspection area being inspected by the technician 120.

In one embodiment, the location module includes an image sensor, such as a camera or infrared sensor, in order to receive images of the vehicle 114. The image sensor can be internal or external to the technician device 115. Location data comprising one or more images can be sent to the dynamic inspection module 105, which can use various image recognition techniques to identify the portion of the vehicle 114 in front of the technician device 115. For example, the dynamic inspection module 105 may receive an image of a portion of the vehicle, for example, the trunk of the vehicle, and compares the image with a database of vehicle images in order to identify the portion of the vehicle. In some embodiments, the vehicle image can be compared with a model of the vehicle. Based on the identified vehicle portion and the location of the camera relative to the vehicle portion, the dynamic inspection module 105 can determine the location of the technician device 115 relative to the vehicle.

In some embodiments, the location module comprises a positional sensor for determining the position of the technician device 115 relative to the vehicle 114. In one embodiment, the position sensor is a Radio Frequency Identification (RFID) tag reader for receiving RFID data from RFID tags, which can be positioned within or around the vehicle and configured to communicate with the RFID reader. For example, RFID tags may be place at the front, rear, left, and/or right sides of an inspection bay such that the RFID can determine a position of the technician device 115 by analyzing the strength of signals received from the one or more RFID tags. For example, if signals are received from RFID tags having strengths, from strongest to weakest, in the order, front, left, right, rear, the dynamic inspection module 105 and/or technician device may determine that the technician is near a front left portion of the vehicle (assuming the vehicle is position in the inspection bay in the same orientation as the RDID tags are labeled). In another embodiment, RFID tags may return data indicating a location of the tags such that signals received by RFID tags can be used to determine a location of the technician device.

In one embodiment, the position sensor is a wireless receiver configured to receive location data from other transmitters located around the vehicle. In one embodiment, the position sensor triangulates the location of the technician device 115 based on the signal strength received from the transmitters. Based on the location data, the dynamic inspection module 105 can determine the location of the technician device 115 relative to the vehicle. In one embodiment, the position sensor comprises a Global Positioning System (GPS) receiver. The GPS receiver can determine the position of the technician device 115 using GPS satellites.

After determining the location of the technician device 115 relative to the vehicle 114, the dynamic inspection module 105 can determine the inspection area being inspected by the technician 120 based on the technician's 120 location. The dynamic inspection module 105 can then generate customized inspection checklists for the particular inspection area using similar techniques as discussed in reference to FIG. 1A.

As will be apparent, the components of dynamic inspection system 100 can be combined or otherwise operate at least partly using the same computing device(s). For example, the dynamic inspection module 105 can include a data source 112 or the technician device 115 can include a camera and/or dynamic inspection module 105. In addition, components may use any type of communications medium to communicate with each other and are not limited to using computer networks. For example, the data source 112 may be connected to the dynamic inspection 105 module through a system bus.

### Example Embodiments—System

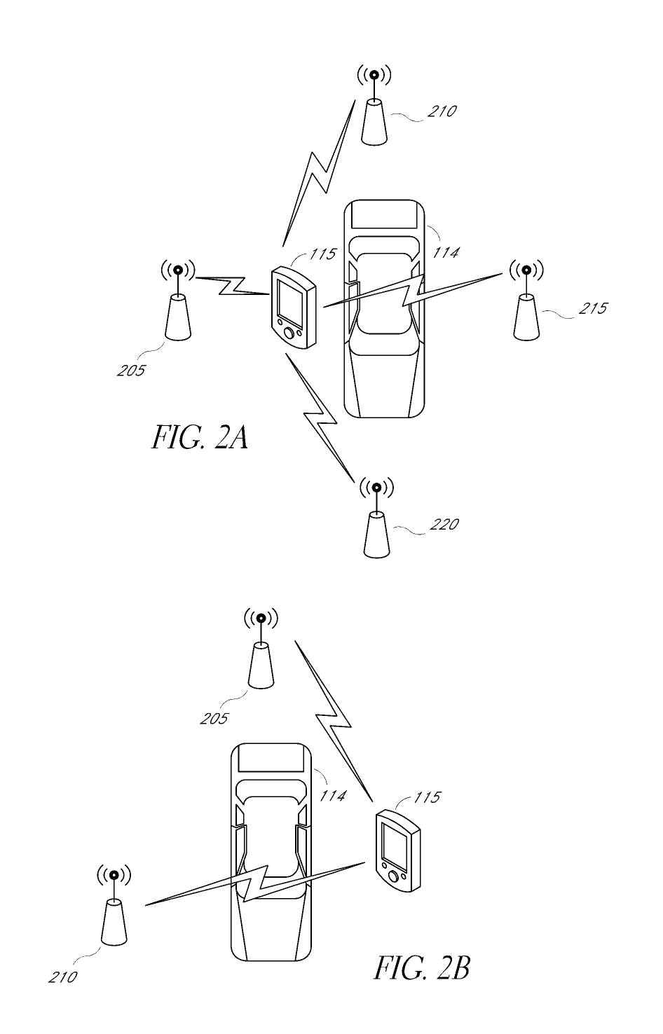

FIGS. 2A-2B illustrate embodiments of the dynamic inspection system 100 including one or more location reporters. The location reporters can include transmitters, receivers, and/or transponders. In FIG. 2A, multiple location reporters 205, 210, 215, 220 can be placed within the automobile inspection and/or repair facility 102. In one embodiment, the location reporters can be placed in locations in a repair bay corresponding to locations on a vehicle, for example, the right side 205, rear 210, left side 215, and front 220 of the vehicle. The technician device 115 can include a wireless receiver configured to receive an electronic signal comprising data from the location reporters. The location data can comprise a signal from which the technician device 115 can determine a signal strength that varies with the distance between the technician device at the respective location reporter, a location reporter ID, a location, and/or other information. In one embodiment, location data can be derived from a property of the electronic signal, such as, for example, the signal strength of the electronic signal. For example, the dynamic inspection system 100 can store the placement of the location reporter in the inspection and/or repair facility and, based on the location reporter ID received on the technician device 115, determine the closest location reporter and thus the location of the technician device 115. In another example, the location reporters can transmit their location, allowing the dynamic inspection system 100 to determine the technician device's 115 location based on the transmitted location of the closest transmitter to the technician device 115. In one embodiment, the technician device 115 includes a transmitter and sends a query signal to a location reporter, which, in response, can generate an electronic signal such as a location signal having location data.

In some embodiments, the technician device 115 determines the closest location reporter based on the signal strength from the location reporter 205. For example, the technician device 115 can receive signals from location reporter 205, 210, 215, 220 of varying strengths based on the distance to the technician device 115 and selects the strongest signal as the signal identifying the closest location reporter 205.

In FIG. 2B, the dynamic inspection system 100 triangulates the location of the technician device 115 based on the signal strength received from the location reporters 205, 210. The dynamic inspection system 100 can receive multiple signals from location reporters and triangulate the location of the technician device 115 based on the relative strengths of the signals. For example, equal signal strength implies that the technician device 115 is equidistant from the location reporters. If the locations of the location reporters 205, 210 are known, then the location of the technician device 115 can be calculated based on the comparative signal strengths of the electronic signal from the location reporters 205, 210.

It will be appreciated that any number of location reporters can be used for determining location, from one to multiple location reporters. Greater numbers of location reporters can provide more granularity in the available location data, for example, by identifying more locations around a vehicle. It will also be appreciated that the location reporters can include any type of transmitters and/or receivers, such as directional and omni-directional.

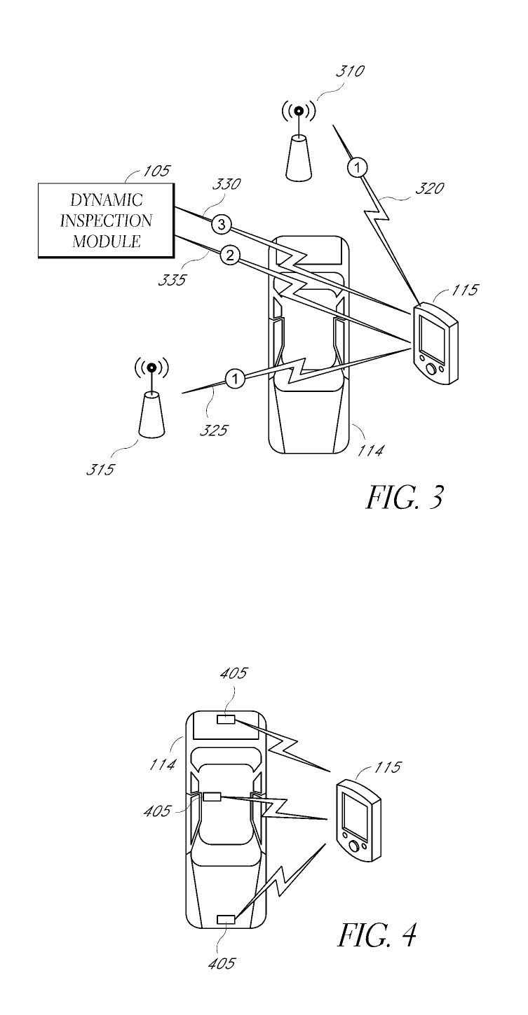

FIG. 3 illustrates an embodiment of the dynamic inspection system 100 using signal strength to determine location. The dynamic inspection module 105 can include a receiver and/or transmitter. FIG. 3 also includes circled numerals that include an exemplary order of transmission of signals between the illustrated devices. In step 1, the technician device 115 receives signals 320, 325 from location reporters 310, 315, respectively. In step 2, the technician device 115 reports some attributes of the signals 320, 325 to the dynamic inspection module 105, which may be simply a strength of the respective signals, or may include alternative and/or additional information regarding the signals 320, 325. In one embodiment, the technician device actually determines its positions with reference to the location reporters 310, 315, based on the received signals 320, 325, for example, by triangulation. In one embodiment, the technician device 115 transmits measurements of the electronic signal which it receives to the dynamic inspection module 105, which can calculate the location of the technician device 115.

In step 3, the dynamic inspection module 105 transmits signal 335 back to the inspection device 115, where the signal 335 includes data for customizing inspection of the vehicle based on the determined location of the technician device 115. In other embodiments, the dynamic inspection module 105 may be part of the inspection device 115, such that step 2 and 3 of FIG. 3 are not necessary.

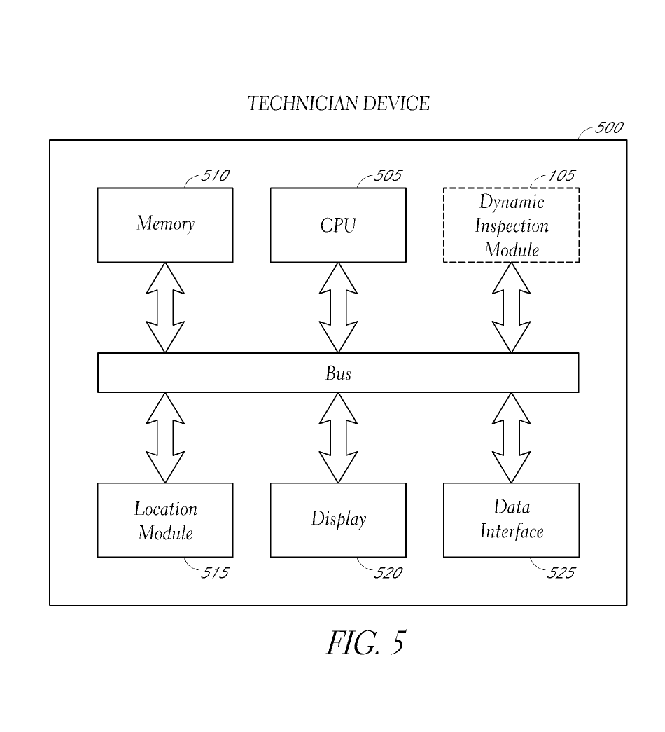

FIG. 4 illustrates an embodiment of the dynamic inspection system 100 using RFID tags to determine location. One or more RFID tags 405 can be placed within, around, or on the vehicle by, for example, a technician 120. The tags can also have been previously installed, for example, by the vehicle manufacturer. The technician device 115 can include a position sensor, such as a Radio Frequency Identification (RFID) tag reader for receiving RFID data from RFID tags configured to transmit location data. For example, one RFID tag located in the engine bay of the vehicle can transmit location data corresponding to the engine bay.

### Example Embodiments—Technician Device

FIG. 5 illustrates a block diagram of an embodiment of the technician device 115. The technician device 115 can comprise a CPU 505, memory 510, such as random access memory (“RAM”) for temporary storage of information and a read only memory (“ROM”) for permanent storage of information, and/or one or more mass storage devices, such as hard drives, diskettes, or optical media storage devices. The technician device 115 can also comprise a location module 515 for obtaining or receiving location data. For example, the location module can be an RFID reader, a receiver, a camera, or the like. The technician device 115 can also include a display device 520, such as a touch screen or a liquid crystal display (LCD), that allows the visual presentation of data to a user. More particularly, a display device provides for the presentation of checklists, GUIs, application software data, and multimedia presentations, for example. The technician device 115 can also include a data interface 525 for receiving and/or transmitting data over a communications link. The communications link can be via a wired and/or wireless communication link, such as Bluetooth, 802.11a/b/g/n, infrared, universal serial bus (USB), IEEE 1394 interface, or the like. The data interface 525 can be used to communicate with data sources, cameras, sensors, a dynamic inspection module 105, and/or other computing devices.

Optionally, the technician device 115 can include the dynamic inspection module 105 that is illustrated as a separate device in the embodiments of FIG. 1A or FIG. 1B. In one embodiment, the technician device 115 receives one or more recommended tasks from the dynamic inspection module 105 for inclusion on a dynamic inspection checklist based on the inspection area. In one embodiment, the technician device 115 can function independently. For example, the technician device 115 can pre-store inspection information using the memory 510, obtain location data using the location module 515, determine the inspection area using the dynamic inspection module 105, and/or generate a dynamic inspection checklist using the CPU 505.

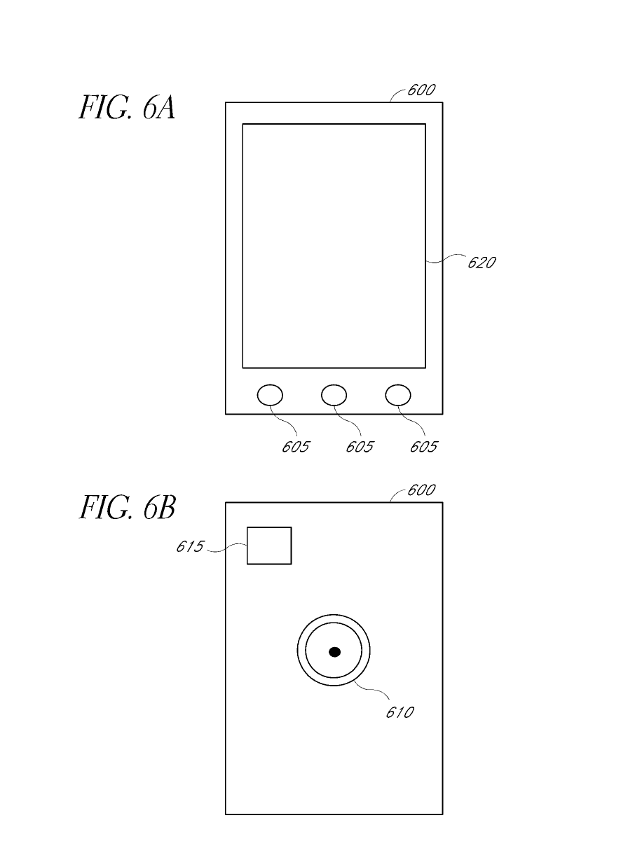

FIG. 6A and FIG. 6B illustrate front and back views, respectively, of an embodiment of a technician device 600. In FIG. 6A, the technician device 600 includes a display 620 and one or more input interfaces 605, such as buttons, dials, a touchpad, a touch screen and/or the like. FIG. 6B illustrates the technician device 600 embodiment including a built-in camera and/or optical sensor 610. Optionally, the technician device 115 can include a camera flash 615 for providing additional lighting.

### Example Embodiments—System Operation

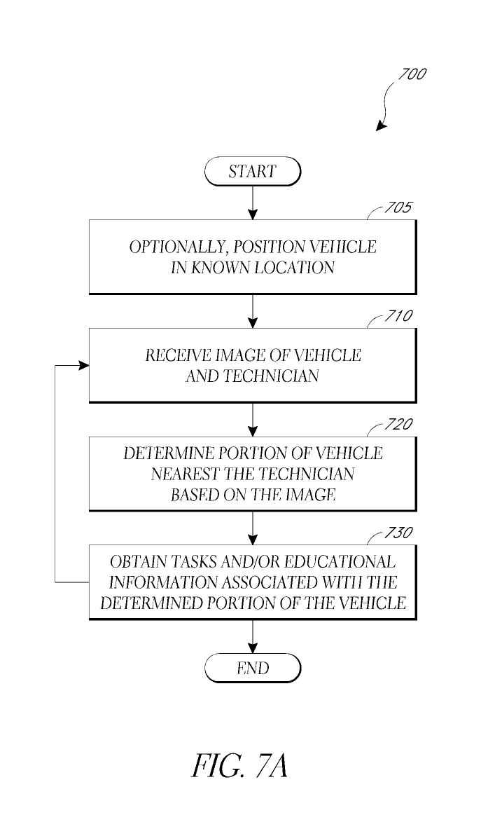

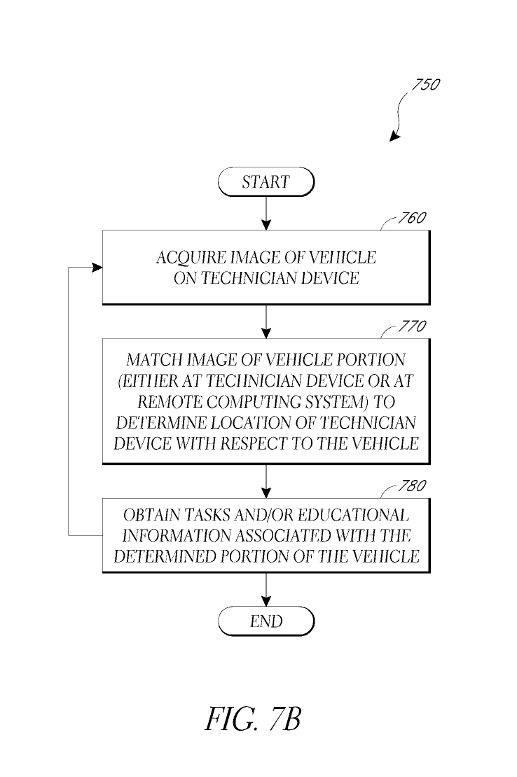

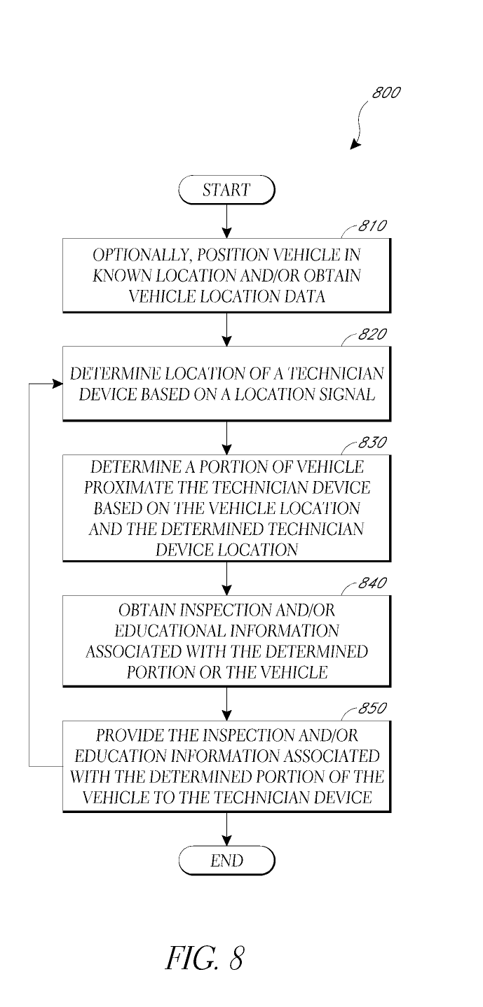

FIG. 7A illustrates a flow chart of an embodiment of a location determination process 700 using images, such as images acquired by one or more cameras 110 (FIG. 1A). The process can be used by, for example, the dynamic inspection module 105 or other portions of the systems illustrated in FIG. 1A or 1B. For example, the technician device 115 may be operated by a technician 120 conducting an inspection of a vehicle 114. As discussed above, images can be still images or video. Depending on the embodiment, the method of FIG. 7A may include fewer or additional blocks and/or the blocks may be performed in a different order than is illustrated. Software code configured for execution on a computing device in order to perform the method of FIG. 7A may be provided on a computer readable medium, such as a compact disc, digital video disc, flash drive, or any other tangible medium. Such software code may be stored, partially or fully, on a memory device of the computer, such as the dynamic inspection module 105 and/or the technician device 115, in order to perform the method outlined in FIG. 7A by those respective devices. For ease of explanation, the method will be described herein as performed by the dynamic inspection module 105; however, the method may be performed by any other suitable computing device.

Beginning at block 705, the location determination process 700 begins with optionally positioning the vehicle 114 in a known location. As discussed above, using a known location and/or orientation provides reference points for the vehicle, facilitating the identification of vehicle portions, such as the front, rear, side, engine, trunk, or the like. For example, the technician 120 may always position the vehicle in a repair bay with the rear of the vehicle at the rear of the repair bay and the front of the vehicle in the front of the repair bay. As the positioning of the repair bay is static and known, the locations of the vehicle portions can be determined by their position relative to the repair bay. However, as discussed above, various image recognition processes can be used to identify vehicle sections if a known location or orientation is unavailable.

Next, at block 710 the dynamic inspection module 105 receives an image of the technician 120 and/or at least a portion of the vehicle 114. The image can be obtained, for example, from one or more cameras in an inspection and/or repair facility or a technician device 115.

Moving to block 720, the dynamic inspection module 105 determines the section of the vehicle nearest the technician 120 based on the image. As discussed above, various image processing techniques can be used to determine the relative position of the technician 120 to the vehicle. For example, techniques such as pose estimation, background subtraction, camera view comparisons between multiple cameras, and/or the like can be used.

At block 730, the dynamic inspection module 105 obtains tasks and/or educational information associated with the determined section of the vehicle. The tasks can be inspection, repair, educational, and/or other information that might be useful to the technician 120 as determined section of the vehicle is inspected. The tasks can be included in a dynamic inspection checklist generated for the user and displayed on the inspection device 115. By facilitating the availability of information pertinent to a particular vehicle location, the user can focus on the subset of tasks related to a particular vehicle section.

In one embodiment, a data mining process, which can be incorporated in or can operate with the dynamic inspection module 105, identifies the tasks and/or educational information from one or more data source 112, for example, using at least one of the make, model, and year of the vehicle. In one embodiment, one or more characteristics of the vehicle, such as miles driven, driving style of the driver, condition of the vehicle, driving environment of the vehicle, or the like may be used by the data mining process to identify vehicles of similar characteristics, not necessarily of the same make, model, or year of the vehicle. Once similar characteristics are identified, tasks and/or educational information are identified based on the one or more characteristics. In one embodiment, the tasks and/or educational information are included on a customized inspection checklist. The customized checklist can be displayed on the technician device 115.

In one embodiment, the process of blocks 710-730 is repeated as the technician 120 moves around the vehicle in order to provide the technician 120 with updated information regarding the particular portion of the vehicle the technician is near. Thus, as the technician 120 moves to another section of the vehicle, the dynamic inspection module 105 receives updated images of the technician and/or vehicle (block 710), determines an updated inspection area of the vehicle, and updates the inspection checklist with information regarding the updated inspection area.

FIG. 7B illustrates a flow chart of another embodiment of a location determination process 750 using an image acquired by the technician device (such as technician device 600). Depending on the embodiment, the method of FIG. 7B may include fewer or additional blocks and/or the blocks may be performed in a different order than is illustrated. Software code configured for execution on a computing device in order to perform the method of FIG. 7B may be provided on a computer readable medium, such as a compact disc, digital video disc, flash drive, or any other tangible medium. Such software code may be stored, partially or fully, on a memory device of the computer, such as the dynamic inspection module 105 and/or the technician device 115, in order to perform the method outlined in FIG. 7A by those respective devices. For ease of explanation, the method will be described herein as performed by the dynamic inspection module 105 and the inspection device 600 (FIG. 6); however, the method may be performed by any other suitable computing devices.

Beginning at block 760, the technician device 600 acquires one or more images of the vehicle 114. The image can be stored on the technician device 600 and/or transmitted to another computing system, such as the dynamic inspection module 105.

Next, at block 770 the dynamic inspection module 105 (whether incorporated in the technician device 600 or as a part of a separate computing device) matches the image of the vehicle section with stored images or characteristics of similar vehicle sections. For example, the dynamic inspection module 105 can match the images with images of vehicles of known makes or models in order to identify the vehicle sections. In one embodiment, the process can use shapes or characteristics of the vehicle section images to identify the vehicle section. Other image recognition processes can be used to determine the vehicle section.

Moving to block 780, the dynamic inspection module obtains inspection and/or educational information associated with the determined section of the vehicle, in a process similar to block 730 described above. In one embodiment, if the technician 120 moves to another section of the vehicle, the process 750, or sections of the process, repeats using new image data. Once the technician completes the inspection, the process 750 can end.

FIG. 8 illustrates a flow chart of another embodiment of a location determination process 800 using an electronic signal. The process can be used by, for example, the dynamic inspection system 100 or components of the system of FIG. 1B. Depending on the embodiment, the method of FIG. 8 may include fewer or additional blocks and/or the blocks may be performed in a different order than is illustrated. Software code configured for execution on a computing device in order to perform the method of FIG. 8 may be provided on a computer readable medium, such as a compact disc, digital video disc, flash drive, or any other tangible medium. Such software code may be stored, partially or fully, on a memory device of the computer, such as the dynamic inspection module 105 and/or the technician device 115, in order to perform the method outlined in FIG. 8 by those respective devices. For ease of explanation, the method will be described herein as performed primarily by the dynamic inspection module 105 (whether as part of an inspection device or as part of a separate computing device); however, the method may be performed by any other suitable computing devices.

At block 810, the location determination process 800 begins with optionally positioning the vehicle 114 in a known location. As discussed above, for example, in block 705, the location of the vehicle and/or sections of the vehicle can be determined by their position relative to the repair bay. However, as discussed above, various image recognition processes can be used to identify vehicle sections if a known location or orientation is unavailable. In one embodiment, an electronic signal, for example, from an RFID tag in the vehicle, can provide information on the location of the vehicle.

Next, at block 820 the dynamic inspection module 105 determines the location of a technician device 115 based on an electronic or location signal comprising location data. As noted above, the location data may simply be a signal strength that is determined by the technician device 115. In other embodiments, the location data may include information identifying the transmitting location device. In one embodiment, the electronic signal comes from one or more RFID tags, or any other devices that can transmit signals, located within or in the vicinity of the vehicle.

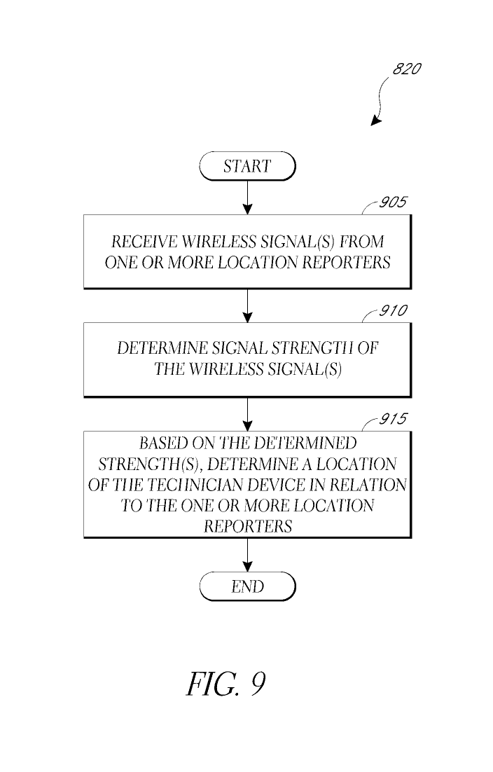

In one embodiment, the electronic signal is generated by one or more location reporters 205 located in the inspection and/or repair facility 102. As discussed above, for example, in FIG. 2A-FIG. 3, the location of the technician device 115 can be determined using signal strengths. Location determination using signal strength is described in further detail below, in FIG. 9.

Moving to block 830, the dynamic inspection module 105 determines a section of vehicle proximate the technician device based on the vehicle location and the determined technician device location. For example, the process 800 can determine that the technician device 115 is near the engine bay of the vehicle based on the location of the device relative to the location of the vehicle. As discussed above, the relative location of the technician device 115 with respect to sections of the vehicle can be determined based on the location data from the location signal.

Next, at block 840 the dynamic inspection module 105 obtains tasks and/or educational information associated with the determined section of the vehicle, in a process similar to block 730 described above.

In block 850, the dynamic inspection module 105 provides the inspection and/or education information associated with the determined section of the vehicle to the technician device 115. The technician device 115 can display the data, for example, in a customized inspection checklist, for use by the technician 120 during an inspection and/or repair.

In one embodiment, as the technician 120 moves to another section of the vehicle, the process 800 or portions of the process repeats (e.g., blocks 820-850), in order to provide the technician with updated information that is relevant to the new location of the technician 120.

FIG. 9 illustrates a flow chart of an embodiment of the technician device location process 820 described in FIG. 8. The location process 820 can be used to determine the location of the technician device 115 based on signal strength of wireless signals. Depending on the embodiment, the method of FIG. 9 may include fewer or additional blocks and/or the blocks may be performed in a different order than is illustrated. Software code configured for execution on a computing device in order to perform the method of FIG. 9 may be provided on a computer readable medium, such as a compact disc, digital video disc, flash drive, or any other tangible medium. Such software code may be stored, partially or fully, on a memory device of the computer, such as the dynamic inspection module 105 and/or the technician device 115, in order to perform the method outlined in FIG. 9 by those respective devices. For ease of explanation, the method will be described herein as performed primarily by the dynamic inspection module 105 (whether as part of an inspection device or as part of a separate computing device); however, the method may be performed by any other suitable computing devices.

Beginning in block 905, the dynamic inspection module 105 receives one or more wireless signals from one or more location reporters. The location reporters can be placed around the inspection bay, for example, or possible on portions of the vehicle. In one embodiment, the locations of the location reporters are stored in a data source and can be used in calculating the location of the technician device 115.

Next, in block 910 dynamic inspection module 105 determines the strength of the one or more wireless signal(s). Generally, the closer the technician device 115 is to the location reporter, the stronger the signal.

Continuing to block 915, dynamic inspection module 105, based on the signal strength(s), determines a location of the technician device in relation to the one or more location reporters. By measuring the signal strength of the wireless signal(s), the dynamic inspection module 105 can determine the distance of the technician device to the location reporters, for example, using triangulation. If the locations of the reporters are known with respect to the vehicle, then the location of the technician device 115 with respect to the vehicle can also be determined. For example, if the technician device is determined to be near a first location reporter that is known to be located near the rear of the vehicle, then the technician device 115 can be determined to be near the rear of the vehicle.

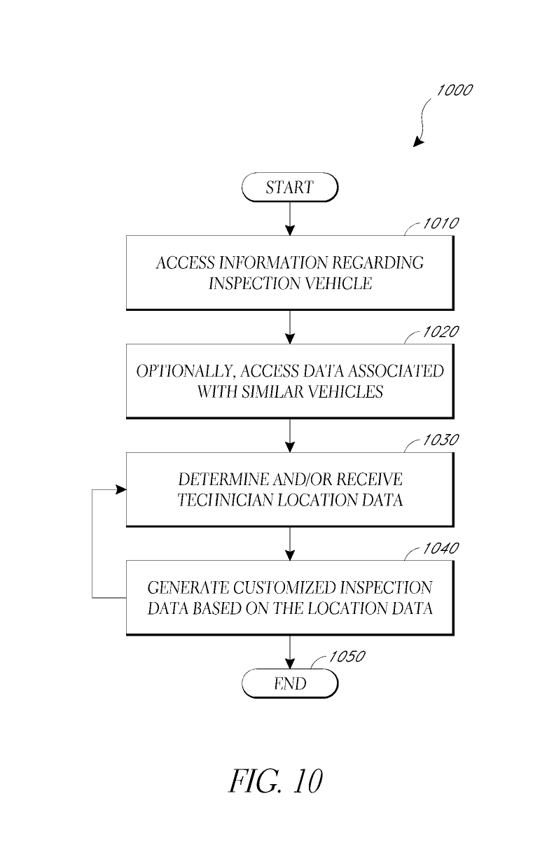

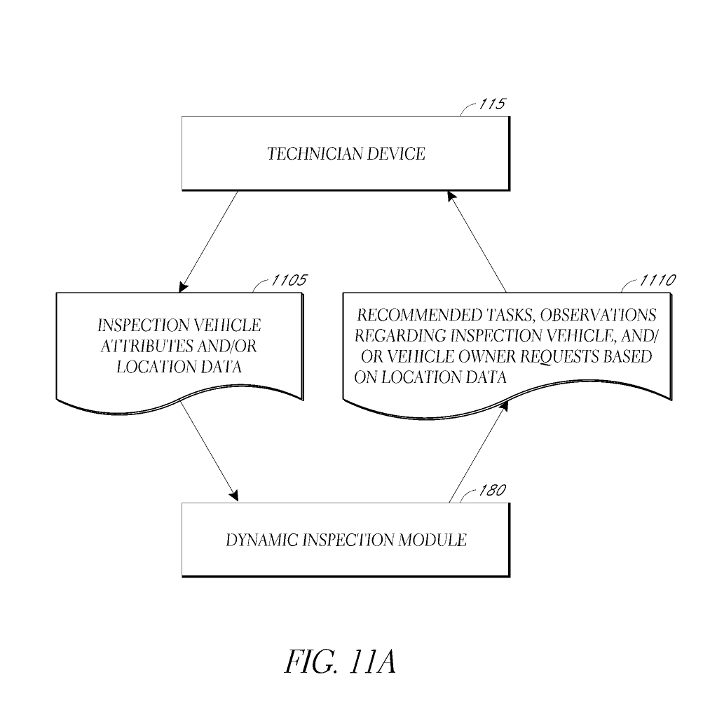

FIG. 10 illustrates a flow chart of an embodiment of a task list generation process 1000 for generating customized inspection lists. The task list generation process 1000 can operate as part of or alongside the dynamic inspection system 100. Depending on the embodiment, the method of FIG. 10 may include fewer or additional blocks and/or the blocks may be performed in a different order than is illustrated. Software code configured for execution on a computing device in order to perform the method of FIG. 10 may be provided on a computer readable medium, such as a compact disc, digital video disc, flash drive, or any other tangible medium. Such software code may be stored, partially or fully, on a memory device of the computer, such as the dynamic inspection module 105 and/or the technician device 115, in order to perform the method outlined in FIG. 10 by those respective devices. For ease of explanation, the method will be described herein as performed primarily by the dynamic inspection module 105 (whether as part of an inspection device or as part of a separate computing device); however, the method may be performed by any other suitable computing devices.

Beginning at block 1010, the dynamic inspection module 105 obtains information stored on a data source 112 regarding the inspection vehicle 114. In one embodiment, the process uses at least one of a make, model, or year of the vehicle to access the information. The information can include task(s) and/or educational information related to the vehicle.

Next, at block 1020, the dynamic inspection module 105 can optionally access information associated with similar vehicles to the inspection vehicle 114. In one embodiment, one or more characteristics of the vehicle, such as miles driven, driving style of the driver, condition of the vehicle, driving environment of the vehicle, or the like may be used by the task list generation process 1000 to identify vehicles of similar characteristics, not necessarily of the same make, model, or year of the vehicle. For example, the information associated with similar vehicles may be requested and received from a smart inspection device, such as devices described in co-pending patent application Ser. No. 12/020,347, filed on Jan. 25, 2008, and entitled “Smart Inspections,” which is hereby incorporated by reference in its entirety for all purposes.

At block 1030, the dynamic inspection module 105 determines and/or receives technician location data. The technician location data can include the relative location of the technician 120 with respect to the vehicle 114. For example, the location data can identify the section of the vehicle proximate to the vehicle. In one embodiment, the identified section of the vehicle is the closest section of the vehicle to the technician 120.

Moving to block 1040, the dynamic inspection module 105 generates customized inspection data based on the location data. The inspection data can include information, such as tasks and/or educational information. In one embodiment, the inspection data is provided as part of a customized inspection checklist. The inspection checklist can be customized by listing task or information based on the current real-time location of the technician. For example, if the technician 120 is near the engine, a first checklist for engine-related tasks is provided. If the technician 120 is inside the vehicle, then a second checklist for interior-related tasks may be provided.

In one embodiment, the dynamic inspection module 105 repeats blocks 1030-1040 in order to receive updated technician location data as the technician moves to another location and generate updated customized inspection data as the technician 120 inspects different sections of the vehicle 114. New checklists can be generated or tasks and/or information can be added or deleted from an existing checklist.

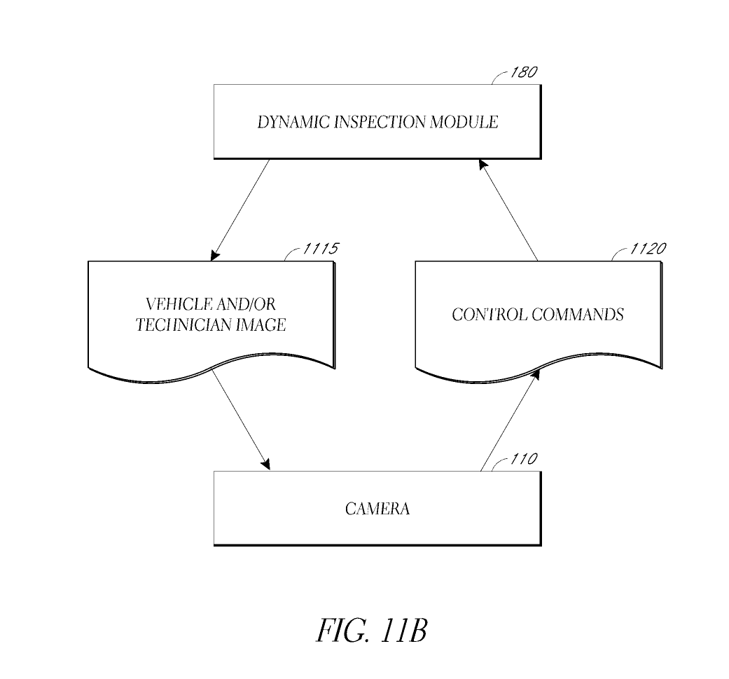

FIG. 11A illustrates a sample data flow between the technician device 115 and an embodiment of the dynamic inspection module 180. For example, the technician device 115 can communicate inspection vehicle attributes and/or location data 1105 to the dynamic inspection module 180. The dynamic inspection module 180 can use that data to determine the relative location of the technician device 115 to the vehicle 114. Based on that determination, the dynamic inspection module 180 can identify and communicate recommended tasks, education information, observations regarding the inspection vehicle 114, and/or vehicle owner requests based on location data 1110.

FIG. 11B illustrates a sample data flow between an embodiment of the dynamic inspection module 180 and at least one camera 110. The dynamic inspection module 180 can communicate control commands 1120 to the camera 110. For example, dynamic inspection module 180 can direct the camera to take an image, focus on a person or object, or provide other operating commands. The camera 110, after taking an image, can communicate a vehicle and/or a technician image 1115 to the dynamic inspection system 100 for use in determining a location of the technician relative to the vehicle, for example.

### Example Embodiments—Inspection Checklist

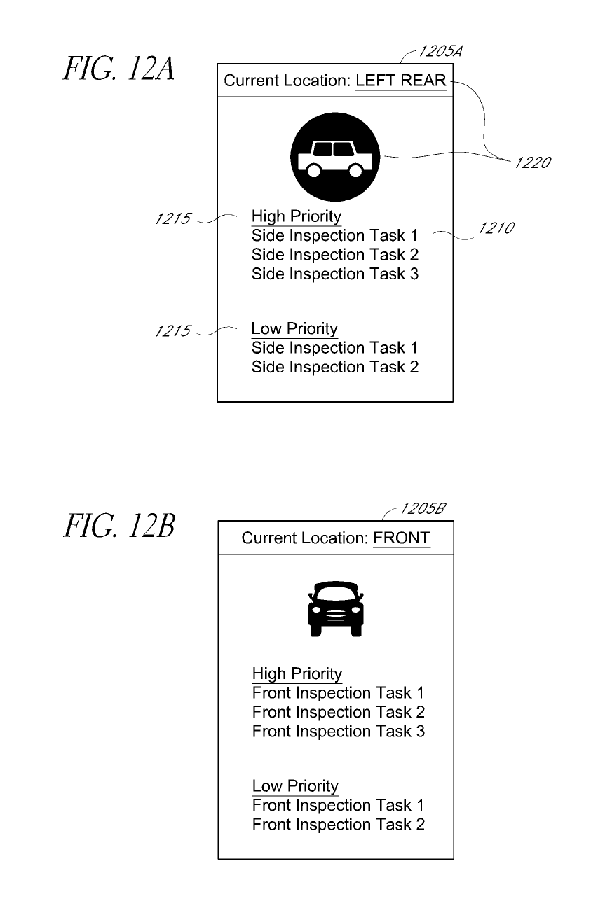

FIGS. 12A-12B illustrates embodiments of a dynamic inspection checklist 1205 generated for specific inspection areas of a vehicle 114. In FIG. 12A, the dynamic inspection checklist 1205A lists inspection items for the left rear of the vehicle 114 (e.g., provided to the technician device in response to determining that the technician is near the left rear of the vehicle). The inspection items can be sorted and/or categorized by various display criteria 1215. For example, inspection items can be sorted by priority, difficulty, cost, or the like. In one embodiment, the dynamic inspection checklist includes an indicator 1220, such as an icon, text, image, or the like 1220, for indicating the current inspection area in order to identify the inspection area location to the technician 120. Such an indicator can serve as verification to the technician 120 that he is reviewing the correct checklist. FIG. 12B is similar to FIG. 12A but illustrates a checklist 1205B for the front of a vehicle 114 (e.g., provided to the technician device in response to determining that the technician is near the front of the vehicle).

By focusing on a particular area, the dynamic inspection checklist can be configured to provide more detailed items and/or additional items than a standard automobile inspection for the whole vehicle. Thus, a dynamic inspection checklist that is used by an inspection/repair technician 120 to perform an inspection of a vehicle may include inspection items specific for a particular inspection area that are not typically on the standard automobile inspection. In this way, the technician 120 that performs the automobile inspection is focused on those inspection items that are most pertinent to the inspection area.

In certain embodiments, the dynamic inspection checklist may include fewer inspection tasks than are on a standard automobile inspection for a whole vehicle. For example, the inspection may be focused only on particular section(s) of the vehicle, such as the engine, as the customer has reported problems for that area, thus other inspection areas are unlikely to need inspection or repair. In this embodiment, the technician 120 is provided with additional time to focus on the more relevant inspection tasks, rather than inspecting items for which there is a low probability that a repair is needed.

### Example Embodiments—Voice Control

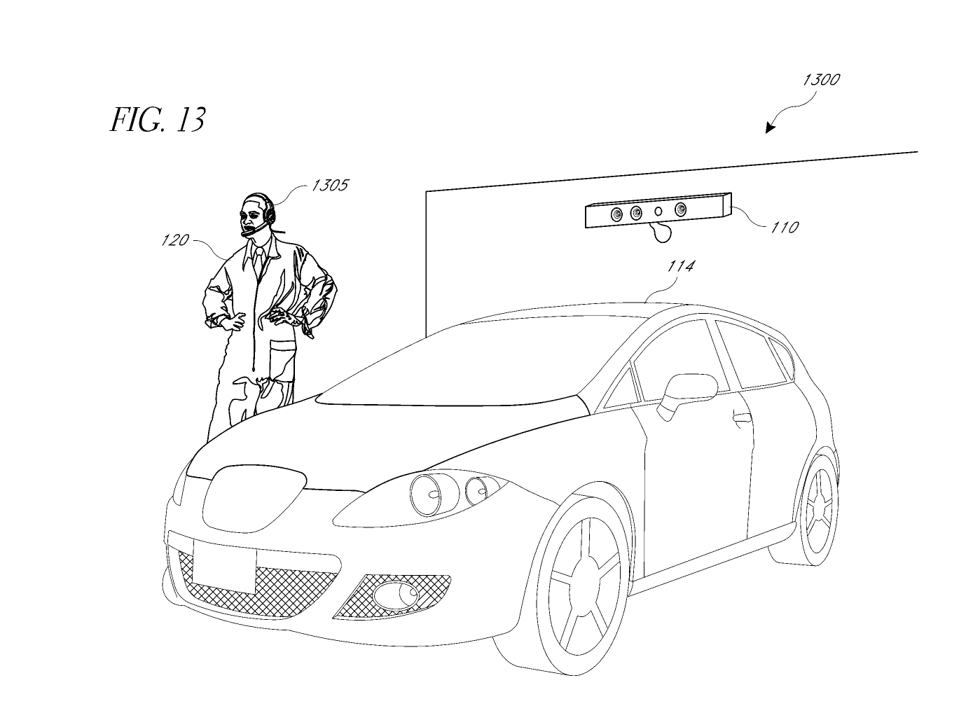

FIG. 13 illustrates an embodiment of the dynamic inspection system 100 configured to accept and respond to voice commands from the technician 120. The dynamic inspection system 100 can include a camera 110, a speaker, a voice receiver and a dynamic inspection module 105. In one embodiment, the voice receiver includes a microphone or a headset 1305 (e.g., BLUETOOTH headset) worm by the technician 120. In one embodiment, the voice receiver includes a receiver for receiving a voice signal, such as a BLUETOOTH, Radio Frequency, or wireless receiver that is in communication with the microphone or headset 1305. For example, the technician 120 can recite commands into the headset 1305 while the technician is performing an inspection that the dynamic inspection system 100 then receives and processes.

In one embodiment, the camera 110 can include a range camera capable of capturing distance information. Range cameras can be used to produce a 2D image showing the distance to points in a scene from a specific point (e.g., the camera location). Range imaging techniques such as stereo triangulation (e.g., using a stereo camera), sheet of light triangulation (e.g., observing a reflected sheet of light), structured light (e.g., using a specially designed light pattern), time-of-flight (e.g., measuring light pulse flight times), interferometry (e.g., measuring phase shift of reflected light relative to a light source), coded aperture (e.g., capturing an image with a specially designed coded aperture pattern) and/or other range imaging techniques can be used to produce a range image. In one embodiment, the range image has pixel values which correspond to the distance, e.g., brighter values mean shorter distance, or vice versa. In one embodiment, a calibrated sensor used to produce the range image can give pixel values in physical units such as meters or feet.

In one embodiment, the camera 110 can include an RGB camera, a depth sensor, and a multi-array microphone. For example, the camera 110 can be a MICROSOFT KINECT or similar device. In one embodiment, the camera 110 can include a control module (e.g., software and/or hardware) which can provide full-body 3D motion capture, facial recognition and/or voice recognition capabilities.

In one embodiment, the control module utilizes facial recognition algorithms, such as geometric (e.g., looking at distinguishing features), photometric (e.g., distilling an image into values and comparing with templates to eliminate variance), 3D face recognition (e.g., capturing a 3D image of the face and identifying distinctive features), and/or skin texture analysis (e.g., using the visual details of the skin). In one embodiment, the control module utilizes voice recognition algorithms such as acoustic modeling and language modeling, which can include Hidden Markov models (e.g., statistical models that output a sequence of symbols or quantities) or Dynamic time warping (e.g., measuring similarities between two sequences that may vary in time or speed).

In one embodiment, the depth sensor includes an infrared laser projector combined with a monochrome CMOS sensor, which captures video data in 3D under various ambient light conditions. In one embodiment, the sensing range of the depth sensor is adjustable, and the control module is capable of automatically calibrating the sensor based on the technician's 120 physical environment, accommodating for the presence of vehicles, furniture or other obstacles.

In one embodiment, the camera 110 can include motors that allow the camera to tilt, pan, or otherwise adjust its field of view. The camera 110 can use the motors to track the technician 120 as the technician moves around the vehicle 114. In one embodiment, the camera 110 may be mounted on a wall of an inspection facility to provide a field of view of an inspection bay.

In one example scenario, the camera 110 detects the technician 120, determines the location of the technician relative to the vehicle 114, determines one or more sections of the vehicle nearest to the technician, and determines applicable commands and/or responses for those determined sections.

In some embodiments, the dynamic inspection system 100 can determine which inspection tasks can be performed at the current location of the technician 120 and determine which voice commands to accept based on the determined inspection tasks. These inspection tasks can be kept on an internal inspection list, which can be stored in a variety of electronic data storage formats (e.g., file, database, etc.). Using the inspection list, the dynamic inspection system 100 can determine what commands can be expected to be received. For example, if the technician 120 is near the engine compartment, the dynamic inspection system 100 can anticipate that voice commands that will be given by the technician 120 are related to engine compartment inspection tasks.

Beneficially, the dynamic inspection system 100 can enhance the accuracy of its voice recognition capability by, for example, limiting its active commands (e.g., commands the dynamic inspection system 100 responds to) to commands related to the current location of the technician. For example, accuracy can be enhanced since there are a fewer number of available voice commands (e.g., those associated with the technician's current position) for a received command to be matched to. With less commands, there are less likely to be close matches that match the sound of the received command, allowing the dynamic inspection system 100 to more easily determine a match. Enhanced accuracy can be particularly beneficial in an inspection facility 102 because of the noise that is typically occurring (e.g., conversation, machinery, vehicle noise, etc.). The dynamic inspection system 100 can use the active commands to filter the audio it receives. For example, the dynamic inspection system 100 can throw out or disregard audio that doesn't match the expected active commands. In one embodiment, the technician 120 can talk with another person while performing an inspection and the dynamic inspection system 100 would disregard the conversion as no active commands are recited. In that embodiment, the technician 120 may not need to worry about affecting the inspection by speaking or performing a non-inspection related task. In one embodiment, voice commands may be provided by the technician 120 in order to change between command modes, such as a command mode (e.g., the system 100 is listening for commands that are relevant to the current position of the technician 120), free speech mode (e.g., where the system 100 does not listen for commands, other than possibly a command that changes the system 100 back into a different mode), and/or other modes.

In some embodiments, the dynamic inspection system 100 can be configured to determine the active commands it responds to based on a position provided by the technician 120. For example, the technician 120 can report to the dynamic inspection system 100 (e.g., via the headset 1305 or a technician device) the technician's current location (e.g., the engine compartment, at passenger door, inside the vehicle, in the driver's seat, at the trunk, or other location). The dynamic inspection system 100 can then filter its active commands to the commands related to the current location of the technician. In some embodiments, the dynamic inspection system 100 does not include a camera 110 for tracking the technician but uses commands, reports, or other indications from the technician to determine the technician's location. In other embodiments, the dynamic inspection system 110 can use a camera 110 or other device to determine the technician's location.

In some embodiments, the dynamic inspection system 100 provides instructions to the technician regarding a next task to be performed on an inspection checklist. For example, after the status of a first inspection task is provided, the system may notify the technician of the next task on the inspection checklist to guide the technician through the checklist. In some situations, providing the notification or otherwise providing an audio interface can allow the technician to complete the inspection without necessarily having any paper and electronics (other than possibly a BLUETOOTH headset), which can simplify the inspection task for the technician. In one embodiment, the system 100 may also provide instructions to the technician on how to complete the inspection task, either automatically or in response to a command from the technician.

In one embodiment, the dynamic inspection system 100 maintains a list of active commands to which it responds. Such commands can include setting the status of an inspection task (e.g., “tire inspection failed”), reciting available inspection tasks, recording voice notes, reciting steps for performing an inspection task, adding future inspection tasks, or the like. For example, the technician 120 can recite a status (e.g., pass, fail, warning, etc.) of a particular inspection task and the dynamic inspection system 100 can then associate the status to the corresponding inspection task. In one embodiment, the active commands change based on the current location of the technician 120. For example, the dynamic inspection system 100 may have a list of 200 available commands that are reduced to 20 commands when the technician is at a first location relative to the vehicle.

In one embodiment, the dynamic inspection system 100 communicates with a display and causes the display to show information (e.g., a report) provided by the dynamic inspection system 100. For example, the dynamic inspection system 100 can keep a running update of the tasks being performed by the technician and the dynamic inspection system 100 can output a real-time or near real-time status of the tasks to the display. In another example, the dynamic inspection system 100 can provide education information (e.g., how to perform a task) in response to a help command from the technician on the display, on a speaker or headset, or on another communication interface. In one embodiment, the display may be part of a technician device 115 of FIG. 1 that the technician is utilizing during the inspection.

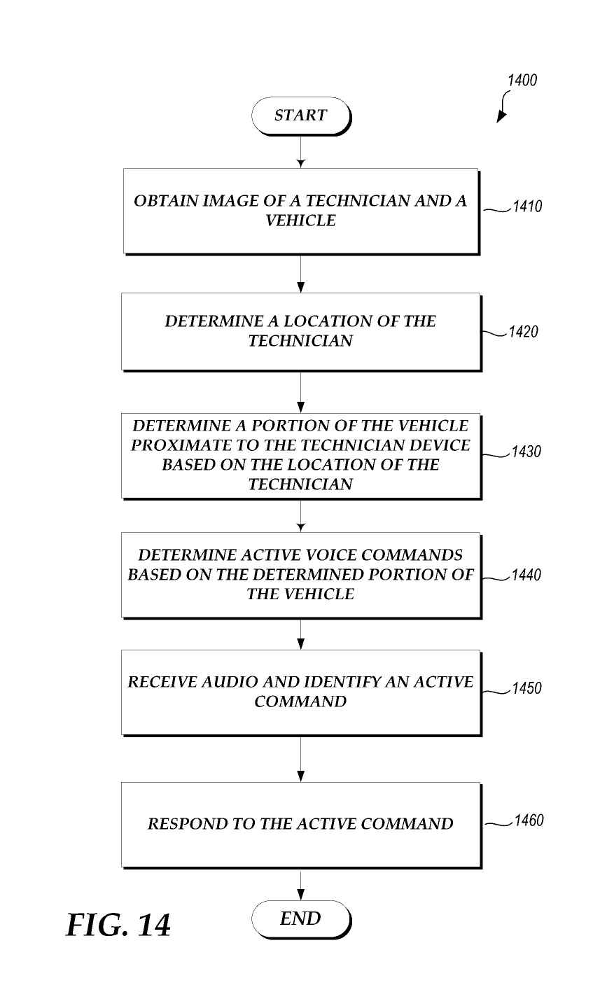

FIG. 14 illustrates a flow chart of another embodiment of a location determination process 1400 using a camera. The process can be used by, for example, the dynamic inspection system 100, such as that described in FIG. 13, or components of the system. Depending on the embodiment, the method of FIG. 14 may include fewer or additional blocks and/or the blocks may be performed in a different order than is illustrated. Software code configured for execution on a computing device in order to perform the method of FIG. 14 may be provided on a computer readable medium, such as a compact disc, digital video disc, flash drive, or any other tangible medium. Such software code may be stored, partially or fully, on a memory device of a computing device, such as the dynamic inspection module 105 or other component of the dynamic inspection system 100. For ease of explanation, the method will be described herein as performed primarily by the dynamic inspection module 105 (whether as part of an inspection device or as part of a separate computing device); however, the method may be performed by any other suitable computing devices.

At block 1410, the location determination process 1400 begins with obtaining at least one image of a technician and a vehicle. As discussed above, in some embodiments, the vehicle can be placed in a known position and/or orientation.

Next, at block 1420 the dynamic inspection module 105 determines the location of the technician based on the at least one image of the technician. The location of the technician may be an absolute coordinate within an area, such as an inspection facility, or may be determined relative to a particular location or object, such as the vehicle or a camera or sensor. As discussed above, the dynamic inspection module 105 can use a variety of algorithms to determine the location of the technician.

Moving to block 1430, the dynamic inspection module 105 determines a section of the vehicle proximate the technician based on the vehicle location and the determined technician location. For example, the process 1400 can determine that the technician 120 is near the engine bay of the vehicle by analyzing the image, identifying the technician, and identifying the section of the car proximate to the technician (e.g., the engine bay). As described above, various algorithms can be used to identify the vehicle section.

Next, at block 1440, the dynamic inspection module 105 determines active voice commands based on the determined portion of the vehicle proximate to the technician. As described above, in one embodiment, the dynamic inspection module 105 responds only to active commands, where the group of active commands it responds to is based at least partly on the location of the technician 120 relative to the vehicle. For example, the group of active commands may be based on the inspection task for the portion of the vehicle nearest the technician. The inspection tasks (as well as education information) can be determined by the dynamic inspection module 105 in a process similar to block 730 described above.

At block 1450, the dynamic inspection module 105 receives audio and identifies an active command. As discussed above, the dynamic inspection module 105 can filter out or disregard sounds that do not include an active command. This can enhance the accuracy and/or responsiveness of the dynamic inspection system 100.

At block 1460, the dynamic inspection module 105 responds to the active command. As discussed above, the dynamic inspection module 105 can respond to various commands and perform various tasks based on those commands. In one example, the dynamic inspection module 105 associates an inspection status with an inspection item. In another example, the dynamic inspection module 105 recites the inspection items for the location of the technician. In another example, the dynamic inspection module 105 recites educational information associative with a particular task in response to a help command from the technician. In one embodiment, the dynamic inspection module 105 ignores commands that aren't active commands. For example, if a command does not involve an inspection item for the section of the vehicle nearest the technician 120 or is otherwise an inactive command, the dynamic inspection module 105 may disregard or ignore the command.

In one embodiment, as the technician 120 moves to another section of the vehicle, the process 1400 or portions of the process repeats (e.g., blocks 1420-1460), in order to provide the technician with updated information that is relevant to the new location of the technician 120.

While the dynamic inspection system 100 has been described in reference to vehicles and/or inspection and/or repair facilities, it will be apparent that the systems and processes described above can be useful in a variety of situations. For example, the dynamic inspection system 100 can be used during manufacturing of a product to provide tasks and/or information to the inspector or assembler. In addition, the dynamic inspection system can be used with any type of vehicle as well as with other objects. For example, the dynamic inspection system could be used during a house inspection.

Depending on the embodiment, certain acts, events, or functions of any of the algorithms described herein can be performed in a different sequence, can be added, merged, or left out all together (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the disclosure described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A computerized method for performing a vehicle inspection, the method comprising:
obtaining, with a camera, one or more images of at least a portion of a vehicle and a technician proximate the vehicle;
determining, based at least on the one or more images, a real-time location of the technician relative to the vehicle;
determining a section of the vehicle proximate to the technician based at least on the real-time location;
determining one or more vehicle inspection tasks associated with the determined section of the vehicle;
receiving a voice command from the technician, the voice command having an inspection task from the one or more vehicle inspection tasks and an inspection task status; and
associating the inspection status with the inspection task associated with the section of the vehicle proximate to the technician;
wherein the method is performed by a computing system having one or more processors.

2. The method of claim 1, wherein a voice command unrelated to the one or more vehicle inspection tasks associated with the determined section of the vehicle is ignored.

3. The method of claim 1, further comprising generating a report showing the status of the one or more inspection tasks.

4. The method of claim 1, further comprising reciting, using an electronic device, the one or more vehicle inspection tasks associated with the determined section of the vehicle to the technician.

5. The method of claim 1, wherein determining one or more inspection tasks is based on one or more of a make, model, and year of the vehicle.

6. The method of claim 1, wherein the one or more vehicle inspection tasks comprises tasks performable by the technician at the proximate vehicle section.

7. The method of claim 1, wherein the one or more vehicle sections comprise at least one of a trunk, engine, driver side, and passenger side of the vehicle.

8. The method of claim 1, wherein the one or more vehicle sections comprises at least one of a front cabin and rear cabin of the vehicle.

9. A system for performing a vehicle inspection, the system comprising:
a camera configured to take at least one image of a vehicle and a user;
a speaker;
a voice-command reception module configured to receive a voice command from the user;
a location module configured to determine a location of the user relative to the vehicle using the at least one image from the camera; and
an inspection module configured to:
determine a vehicle section proximate to the user based on the determined location of the user;
determine vehicle data associated with the determined vehicle section; and
in response to receiving a voice command from the user, recite the vehicle data using the speaker.

10. The system of claim 9, wherein the camera includes a motion sensor.

11. The system of claim 9, wherein the camera includes an infrared sensor.

12. The system of claim 9, wherein the camera includes a range camera.

13. The system of claim 9, wherein the inspection module is configured to determine the vehicle section proximate to the user by performing an image analysis on the image from the camera.

14. The system of claim 9, wherein the voice-command reception module comprises a microphone.

15. The system of claim 9, wherein the voice-command reception module receives the voice command from a headset worn by the user.

16. The system of claim 9, wherein the vehicle data comprises one or more inspection tasks.

17. The system of claim 16, wherein the vehicle data comprises educational information related to the one or more inspection tasks.

18. Physical computer storage having stored thereon instructions that, in response to execution by a computing system having one or more hardware processors, cause the computing system to:
obtain one or more images of at least a portion of a vehicle and a technician proximate the vehicle;
determine, based at least on the one or more images, a location of the technician relative to the vehicle;
determine a section of the vehicle proximate to the technician based at least on the real-time location;
determine one or more active voice commands based on the determined section of the vehicle;
identify an active voice command from the technician; and
respond to the voice command by performing a task associated with the voice command.

19. The computer storage of claim 18, wherein the computing system is configured to identity an active voice command by filtering received sound based on the active voice commands.

20. The computer storage of claim 18, wherein the computing system is configured to disregard non-active voice commands.
